(19) United States
(12) Patent Application Publication
(10) Pub. No.: US 2020/0125055 A1
(43) Pub. Date: Apr. 23, 2020

(54) ELECTRONIC DEVICE AND METHOD FOR REMOTE CONTROL OF FACILITIES

(71) Applicant: Shenzhen Jingjiang Yunchuang Technology Co., Ltd., Shenzhen (CN)

(72) Inventor: XUE-QIN ZHANG, Shenzhen (CN)

(21) Appl. No.: 16/558,582

(22) Filed: Sep. 3, 2019

(30) Foreign Application Priority Data
Oct. 23, 2018 (CN) 201811240223.X

(51) Int. Cl. G05B 19/048

(52) U.S. Cl. CPC G05B 19/048; G05B 2219/1204; G05B 2219/25232

(57) ABSTRACT

A method applied in an electronic device for remote control of facilities in a first group includes generating control data according to component information taken from facilities in a second group used as a model for the facilities in the first group. The component information is stored in a storage device of the electronic device ready for when the facilities in the first group are remotely controlled. The control data is transmitted to a first device for remotely controlling operation of the facilities in the first group and the first device is controlled to acquire feedback generated by each of the facilities in the first group during the operation, the feedback data transmitted by the first device being received by the electronic device.

### CROSS-REFERENCE TO RELATED APPLICATIONS

This application claims priority to Chinese Patent Application No. 201811240223.X filed on Oct. 23, 2018, the contents of which are incorporated by reference herein.

### FIELD

The subject matter herein generally relates to remote control technology, and particularly to an electronic device and a method for remote control of facilities.

### BACKGROUND

In processes of industrial production, remote control of automated facilities in factories is often required. Remote control of automated facilities requires facility information, such as model, temperature, working current etc. However, when a factory has a large amount of facilities, due to lack of historical data, the acquiring of facility information may take a lot of time, which leads to reduced efficiency in remote control.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device.

FIG. 2 is a block diagram of an embodiment of a remote control system of the electronic device.

FIG. 3 illustrates a flowchart of an embodiment a method for remote control of facilities.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

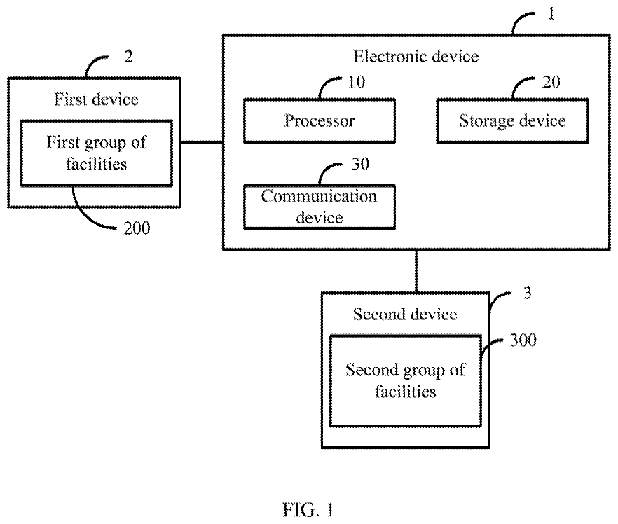

FIG. 1 illustrates a block diagram of an embodiment of an electronic device 1 for remote control of facilities. In at least one embodiment, the electronic device 1 can be a server or cloud server. The electronic device 1 can communicate with a number of facilities, and remotely control operation of the number of facilities.

In at least one embodiment, the electronic device 1 includes, but is not limited to, a processor 10, a storage device 20, and a communication device 30. The electronic device 1 runs a remote control system 100. The remote control system 100 is used to remotely control the number of facilities. FIG. 1 illustrates only one example of the electronic device 1, other examples can include more or fewer components than illustrated, or have a different configuration of the various components in other embodiments.

The processor 10 can be a central processing unit (CPU), a microprocessor, or other data processor chip that performs functions of the electronic device 1.

In at least one embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium.

In at least one embodiment, the communication device 1 can be a WI-FI device or a wired device. When the communication device 1 is the WI-FI device, the electronic device 1 communicates with the number of facilities through WLAN (Wireless Local Area Network) or Internet. When the communication device 1 is the wired device, the electronic device 1 communicates with the number of facilities through cables.

In at least one embodiment, the number of facilities include a first group 200 of facilities and a second group 300 of facilities. The communication device 30 respectively communicates with the first group 200 and the second group 300 of facilities through a first device 2 and a second device 3. In at least one embodiment, the first device 2 and the second device 3 can be personal computers or servers. The first device 2 and the second device 3 can acquire and transmit facility information, control information of the facilities, and feedback information of the facilities.

In at least one embodiment, the first device 2 and the second device 3 communicate with the facilities through an industrial communication protocol (e.g. Module Bus, RS232, RS485), a local area network (LAN), and a system serial bus (e.g. Inter-integrated Circuit, I2C).

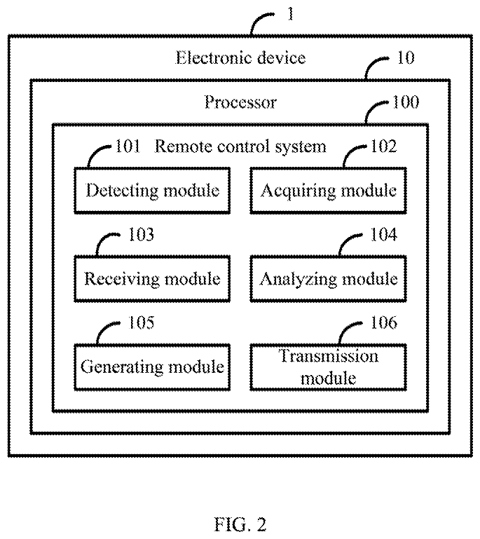

Referring to FIG. 2, the remote control system 100 at least includes a detecting module 101, an acquiring module 102, a receiving module 103, an analyzing module 104, a generating module 105, and a transmission module 106. The modules 101-106 can be collections of software instructions stored in the storage device 20 of the electronic device 1 and executed by the processor 10. The modules 101-106 also can include functionality represented as hardware or integrated circuits, or as software and hardware combinations, such as a special-purpose processor or a general-purpose processor with special-purpose firmware.

In at least one embodiment, the first device 2 and the first group 200 of facilities are in one factory, the second device 3 and the second group 300 of facilities are in another factory. The facilities in the first group 200 and the second group 300 are the same. The facilities in the first group 200 are taken as facilities to be remotely controlled. The information in relation to the facilities in the second group 300 are taken as basic data of remote control of the facilities in the first group 200.

The detecting module 101 is used to control the second device 3 to detect whether at least one predetermined condition of acquiring component information is activated at predetermined time intervals.

In at least one embodiment, the component information is in relation to the facilities in the second group 300. The predetermined time interval can be five minutes.

In at least one embodiment, the component information at least includes a model number, a manufacturer, a size, a shape, material, functions, a production date, an installation date, an installation location, control interfaces, and control commands of each facility.

In at least one embodiment, the at least one predetermined condition of acquiring component information includes component replacement, component maintenance, component assembly, scanning a code of component, and capturing an image of component. That is, when at least one component is replaced, maintained, and/or assembled, and/or the code of the at least one component is scanned and/or the image of the at least one component is captured, the second device 3 determines that the at least one predetermined condition of acquiring component information is activated.

In at least one embodiment, the code of the at least one component can be a barcode or a QR code.

When the second device 3 detects that the at least one predetermined condition of acquiring component information is activated, the acquiring module 102 is used to control the second device 3 to acquire the component information of the facilities in the second group 300.

In at least one embodiment, when at least one component is replaced, maintained, and/or assembled, updated information of the at least one component is input into the second device 3 by a user through an input device (not shown), such as a keyboard, and the second device 3 can thus acquire the component information. When the code of the at least one component is scanned by a scanning device (not shown), such as a laser, and/or the image of the at least one component is captured by a camera device (not shown), the second device 3 can acquire the component information through the scanning device and the camera device.

The receiving module 103 is used to receive the component information of the facilities in the second group 300 transmitted by the second device 3.

In at least one embodiment, the second device 3 further transmits the acquired component information to the electronic device 1, and the receiving module 103 receives the component information transmitted by the second device 3.

The analyzing module 104 is used to determine authenticity of the received component information.

In at least one embodiment, the analyzing module 104 determines whether the storage device 20 previously stores information of the at least one component of the facilities in the second group 300. When the storage device 20 previously stores the information of the at least one component of the facilities in the second group 300, the analyzing module 104 compares the received component information with the corresponding information of the at least one component stored in the storage device 20.

When at least one difference exists between the received component information and the corresponding information of the at least one component stored in the storage device 20, but such difference is within an allowable error range, the analyzing module 104 determines that the received component information is authentic, and stores the received component information to the storage device 20.

When such difference exceeds the allowable error range, the analyzing module 104 determines that the received component information is not authentic, and removes the received component information.

When the storage device 20 does not previously store the information of the at least one component of the facilities in the second group 300, the analyzing module 104 determines whether the received component information is authentic according to an audit carried out by the user.

The generating module 105 is used to generate control data according to the component information, when the facilities in the first group 200 are remotely controlled.

In at least one embodiment, when the facilities in the first group 200 are remotely controlled, the first device 2 transmits an instruction for requesting the control data to the electronic device 1. When the electronic device 1 receives the instruction, the generating module 105 generates the control data.

In at least one embodiment, the control data includes, but is not limited to, information of control flow, control instructions, and control functions. In detail, the information of control flow can include, but is not limited to, steps of control flow, control parameters, logical relationships between the control parameters, and logic relationships between the control instructions.

The transmission module 106 is used to transmit the control data to the first device 2 for remotely controlling operation of the facilities in the first group 200.

In at least one embodiment, when the first device 2 receives the control data, the first device 2 controls the facilities in the first group 200 to operate according to the control data.

In detail, the first device 2 transmits the control data to control unit of each facility in the first group 200, the control unit transmits the control instructions to the components and/or instruction execution units in each facility, and controls the components and/or the instruction execution units to operate, according to the steps of control flow and the control parameters, thus realizing the control functions.

The acquiring module 102 is further used to control the first device 2 to acquire feedback data generated by each facility in the first group 200.

In at least one embodiment, the feedback data is generated when each facility is operating, the feedback data at least includes operation data, measurement data, and fault data.

In detail, the operation data at least includes temperature, humidity, working current, working voltage, operation mode, operation speed, acceleration, operation height, operation position, angle, and direction of each component during the operation of the facility. The measurement data can be measurements generated by each facility. Fault data at least includes fault numbers, fault types, and fault causes.

The receiving module 103 is further used to receive the feedback data transmitted by the first device 2, and store the feedback to the storage device 20.

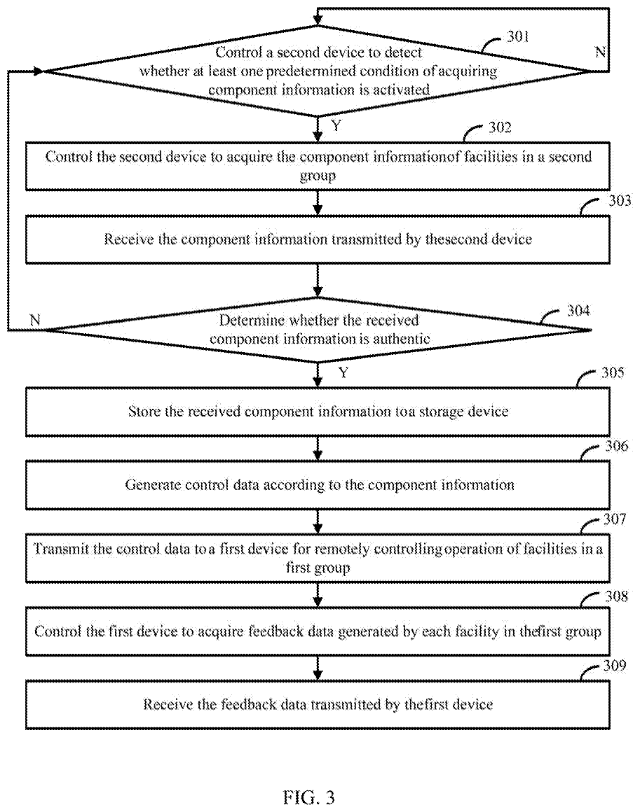

FIG. 3 illustrates a flowchart of an embodiment of a method for remote control of facilities. The method is provided by way of example, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 301.

At block 301, the detecting module 101 controls the second device 3 to detect at predetermined time intervals whether at least one predetermined condition of acquiring component information is activated. If the at least one predetermined condition of acquiring component information is activated, the process goes to block 302. If the at least one predetermined condition of acquiring component information is not activated, the process continues in block 301.

At block 302, the acquiring module 102 controls the second device 3 to acquire the component information of the facilities in the second group 300.

At block 303, the receiving module 103 receives the component information of the facilities in the second group 300 transmitted by the second device 3.

At block 304, the analyzing module 104 determines whether the received component information is authentic. If the received component information is found to be authentic, the process goes to block 305. If the received component information is found to be not authentic, the process goes back to block 301.

At block 305, the analyzing module 104 stores the received component information to the storage device 20.

At block 306, the generating module 105 generates control data according to the component information, when the facilities in the first group 200 are remotely controlled.

At block 307, the transmission module 106 transmits the control data to the first device 2 for remotely controlling the operation of the facilities in the first group 200.

At block 308, the acquiring module 102 further controls the first device 2 to acquire feedback data generated by each facility in the first group 200.

At block 309, the receiving module 103 further receives the feedback data transmitted by the first device 2.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. An electronic device comprising:
at least one processor;
a communication device coupled to the at least one processor and communicating with a first device, wherein the first device communicates with a first group of facilities; and
a storage device storing component information of the facilities, and coupled to the at least one processor and storing instructions for execution by the at least one processor to cause the at least one processor to:
generate control data according to the component information stored in the storage device when the facilities in the first group are remotely controlled;
transmit the control data to the first device for remotely controlling operation of the facilities in the first group;
control the first device to acquire feedback data generated by each of the facilities in the first group during the operation of each of the facilities; and
receive the feedback data transmitted by the first device.

2. The electronic device according to claim 1, wherein the communication device further communicates with a second device, and the second device communicates with a second group of facilities, the at least one processor is further caused to:
control the second device to acquire component information of facilities in the second group;
receive the component information transmitted by the second device; and
store the received component information to the storage device.

3. The electronic device according to claim 2, wherein the at least one processor is further caused to:
determine whether the received component information is authentic;
store the received component information to the storage device when the received component information is authentic; and
remove the received component information when the received component information is not authentic.

4. The electronic device according to claim 2, wherein the at least one processor is further caused to:
control the second device to detect whether at least one predetermined condition of acquiring component information is activated at predetermined time intervals; and
control the second device to acquire the component information of the facilities in the second group when the at least one predetermined condition of acquiring component information is activated.

5. The electronic device according to claim 4, wherein the at least one predetermined condition comprises component replacement, component maintenance, component assembly, scanning a code of a component, and capturing an image of the component.

6. The electronic device according to claim 1, wherein the component information comprises a model number, a manufacturer, a size, a shape, material, functions, a production date, an installation date, an installation location, control interfaces, and control commands of each component of the facilities in the second group.

7. The electronic device according to claim 1, wherein the control data comprises information of control flow, control instructions, and control functions, the information of control flow comprises steps of control flow, control parameters, logical relationships between the control parameters, and logic relationships between the control instructions.

8. The electronic device according to claim 1, wherein the feedback data comprises operation data, measurement data, and fault data, the operation data comprises temperature, humidity, working current, working voltage, operation mode, operation speed, acceleration, operation height, operation position, angle, and direction of each component during the operation of the facility, the measurement data are measurements generated by each facility, and fault data comprises fault numbers, fault types, and fault causes.

9. A method for remote control of facilities applicable in an electronic device comprising:
generating control data according to component information stored in a storage device of the electronic device when facilities in a first group are remotely controlled;
transmitting the control data to a first device communicating with the electronic device for remotely controlling operation of the facilities in a first group;
controlling the first device to acquire feedback data generated by each of the facilities in the first group during the operation of each of the facilities; and
receiving the feedback data transmitted by the first device.

10. The method according to claim 9, further comprising:
controlling a second device communicating with the electronic device to acquire component information of facilities in a second group;
receiving the component information transmitted by the second device; and
storing the received component information to the storage device.

11. The method according to claim 10, further comprising:
determining whether the received component information is authentic;
storing the received component information to the storage device when the received component information is authentic; and
removing the received component information when the received component information is not authentic.

12. The method according to claim 10, further comprising:
controlling the second device to detect whether at least one predetermined condition of acquiring component information is activated at predetermined time intervals; and
controlling the second device to acquire the component information of the facilities in the second group when the at least one predetermined condition of acquiring component information is activated.

13. The method according to claim 12, wherein the at least one predetermined condition comprises component replacement, component maintenance, component assembly, scanning a code of a component, and capturing an image of the component.

14. The method according to claim 9, wherein the component information comprises a model number, a manufacturer, a size, a shape, material, functions, a production date, an installation date, an installation location, control interfaces, and control commands of each component of the facilities in the second group.

15. The method according to claim 9, wherein the control data comprises information of control flow, control instructions, and control functions, the information of control flow comprises steps of control flow, control parameters, logical relationships between the control parameters, and logic relationships between the control instructions.

16. The method according to claim 9, wherein the feedback data comprises operation data, measurement data, and fault data, the operation data comprises temperature, humidity, working current, working voltage, operation mode, operation speed, acceleration, operation height, operation position, angle, and direction of each component during the operation of the facility, the measurement data are measurements generated by each facility, and fault data comprises fault numbers, fault types, and fault causes.
